(19) United States
(12) Patent Application Publication
(10) Pub. No.: US 2020/0007431 A1
(43) Pub. Date: Jan. 2, 2020

(54) RELIABILITY EVALUATING METHOD FOR MULTI-STATE FLOW NETWORK AND SYSTEM THEREOF

(71) Applicant: NATIONAL TSING HUA UNIVERSITY, HSINCHU (TW)

(72) Inventors: WEI-CHANG YEH, HSINCHU (TW); WEI-HUNG YEH, FREMONT, CA (US)

(21) Appl. No.: 16/139,463

(22) Filed: Sep. 24, 2018

(30) Foreign Application Priority Data
Jun. 27, 2018 (TW) 107122053

(51) Int. Cl. H04L 12/733; H04L 12/721; H04L 12/725; H04L 12/933

(52) U.S. Cl. CPC H04L 45/122; H04L 49/1553; H04L 45/306; H04L 45/38

(57) ABSTRACT

A reliability evaluating method for a multi-state flow network and a system thereof are presented. The method includes following steps: finding candidate path sets included in the multi-state flow network; converting the candidate path sets into candidate path values according to a prime number function; removing the repeated candidate path values to keep the corresponded candidate path sets as the non-repeated minimal path; calculating the reliability of the multi-state flow network based on the data flow and data load of the minimal path sets.

This application claims priority from Taiwan Patent Application No. 107122053, filed on Jun. 27, 2018, in the Taiwan Intellectual Property Office, the content of which is hereby incorporated by reference in its entirety for all purposes.

### FIELD OF THE INVENTION

The present disclosure relates to a reliability evaluating method for a multi-state flow network and a system thereof, especially referring to a reliability evaluating method and a system thereof for a multi-state flow network capable of quickly and accurately sifting candidate solutions to improve operational efficiency.

### BACKGROUND OF THE INVENTION

Multi-state flow networks are currently used as analytical network models by using a plurality of nodes and a plurality of arcs connected to the plurality of nodes. In the application of computer communication systems, transportation systems, oil/gas production transmission systems, power distribution systems, etc., the actual operational status can be simulated and analyzed by the network model. Moreover, references for system decision-making can be provided by the evaluation of network reliability to find the best implementation plan.

For conventional multi-state flow network analysis, every possible transmission path or transmission load has to be found when calculating reliability. The reliability of data transmission is calculated by analyzing the possible transmission paths or transmission loads as mentioned above. However, several repetitive schemes are usually generated when finding every possible, feasible solution or listing out every possible candidate solution. If a sifting procedure is not performed first, follow-up calculations on repeated data will result in a waste of operational resources and a decrease in operational efficiency. If the existing sifting methods are considered, that is, comparing each candidate solution set with other candidate solution sets respectively, too much time will be spent on comparison. Even if sorting the elements in a candidate solution set is considered, complicated operational procedures are still inevitable for sorting and sifting all of the sets. Therefore, for reliability analysis of calculating multi-state flow networks, designing an effective sifting method plays a crucial role in either simplification of operational complexity or enhancement of operational efficiency.

In view of what is mentioned above, the inventor of the present disclosure has designed a reliability evaluating method for a multi-state flow network and a system thereof, which can swiftly sift repeated sets to improve deficiencies in terms of current techniques so as to enhance the implementation and application in industries.

### SUMMARY OF THE INVENTION

In view of the above-mentioned problems, the present disclosure provides a reliability evaluating method for a multi-state flow network and a system thereof to solve the problem of decrease in operational efficiency owing to increase in operational complexity caused by repeated sets of conventional multi-state flow networks.

According to one purpose of the present disclosure, a reliability evaluating method for a multi-state flow network is provided. A multi-state flow network is stored in a memory. The multi-state flow network includes a plurality of nodes and a plurality of arcs connected to the plurality of nodes. The plurality of nodes includes a source node and a sink node. The reliability evaluating method includes the following steps:
a. finding a plurality of candidate path sets formed by all of the paths from the source node to the sink node by a processor in the multi-state flow network;
b. converting the plurality of candidate path sets into a plurality of candidate path values by the processor according to a prime number function;
c. sifting the plurality of candidate path sets to remove the repeated values from the plurality of candidate path values, and keep the plurality of non-repeated candidate path sets by the processor to form a plurality of minimal paths;
d. calculating the plurality of nodes, and a data flow and a data load of the plurality of arcs in the plurality of minimal paths by the processor to form a system state of each of the plurality of minimal paths; and
e. calculating a reliability of the multi-state flow network by the processor according to the system state.

Preferably, the prime number function may include a product value of a plurality of non-repeated prime numbers with an exponentiation operation, shown as P(s)=pᵢ^{e}^{ᵢ}×pᵢ₊₁^{e}^{ᵢ₊₁}× . . . ×pₙ^{e}^{ₙ}, wherein s represents the plurality of candidate path sets, eᵢ represents the i-th element in the plurality of candidate path sets, pᵢ represents the i-th non-repeated prime number, and n represents the number of elements.

Preferably, the prime number function may include a logarithmic value of the product value of the plurality of non-repeated prime numbers with the exponentiation operation, shown as L(s)=L(P(s)), wherein L(P(s)) represents the logarithmic value of P(s).

Preferably, the system state of the plurality of minimal paths may be converted into a plurality of system state values according to the prime number function and the plurality of system state values are sifted to keep the non-repeated values corresponded to the system state.

According to another purpose of the present disclosure, a reliability evaluating system for a multi-state flow network applicable to a multi-state flow network is provided. The multi-state flow network includes a plurality of nodes and a plurality of arcs connected to the plurality of nodes. The plurality of nodes includes a source node and a sink node. The reliability evaluating system includes a memory and a processor; wherein, the memory is used to store the multi-state flow network and an algorithm, and the processor is connected to the multi-state flow network and the memory. The processor also executes the algorithm to obtain the reliability of the multi-state flow network. This algorithm includes the following steps:
a. finding a plurality of candidate path sets formed by all of the paths from the source node to the sink node in the multi-state flow network;
b. converting the plurality of candidate path sets into a plurality of candidate path values according to a prime number function;
c. sifting the plurality of candidate path sets to remove repeated values from the plurality of candidate path values, and keep the plurality of non-repeated candidate path sets to form a plurality of minimal paths;
d. calculating the plurality of nodes, and a data flow and a data load of the plurality of arcs in the plurality of minimal paths to form a system state of each of the plurality of minimal paths; and
e. calculating a reliability of the multi-state flow network according to the system state.

Preferably, the prime number function may include a product value of a plurality of non-repeated prime numbers with an exponentiation operation, shown as P(s)=pᵢ^{e}^{ᵢ}×pᵢ₊₁^{e}^{ᵢ₊₁}× . . . pₙ^{e}^{ₙ}, wherein s represents the plurality of candidate path sets, eᵢ represents the i-th element in the plurality of candidate path sets, pᵢ represents the i-th non-repeated prime number, and n represents the number of elements.

Preferably, the prime number function may include a logarithmic value of the product value of the plurality of non-repeated prime numbers with the exponentiation operation, shown as L(s)=L(P(s)), wherein L(P(s)) represents the logarithmic value of P(s).

Preferably, the system state of the plurality of minimal paths may be converted into a plurality of system state values according to the prime number function and the plurality of system state values are sifted to keep the non-repeated values corresponded to the system state.

In view the previous statements, the reliability evaluating method for the multi-state flow network and the system thereof regarding the present disclosure has more than one advantage stated as follows:

(1) The reliability evaluating method for the multi-state flow network and the system thereof can sift the candidate path sets of the multi-state flow network and the system state sets, and remove repeated sets to decrease a waste on operational resources caused by repeated operation to further enhance operational efficiency.

(2) The reliability evaluating method for the multi-state flow network and the system thereof can calculate the reliability of the multi-state flow network, which can be regarded as a basis for decision-making on transmission states of a multi-state flow network.

(3) The reliability evaluating method for the multi-state flow network and the system thereof can decrease the digits for calculation to lower the threshold for operational processing capacity and increase the convenience and practicality on operation by using the prime number functions and the combination of the logarithmic values.

### BRIEF DESCRIPTION OF THE DRAWINGS

FIG. 1 is a schematic diagram of the multi-state flow network of the embodiment of the present disclosure.

FIG. 2 is a flow chart of the reliability evaluating method for the multi-state flow network of the embodiment of the present disclosure.

FIG. 3 is a schematic diagram of the multi-state flow network of the other embodiment of the present disclosure.

FIG. 4 is a schematic diagram of the reliability evaluating system for the multi-state flow network of the embodiment of the present disclosure.

### DETAILED DESCRIPTION OF THE ILLUSTRATED EMBODIMENTS

To facilitate the review of the technique characteristics, contents, advantages, and achievable effects of the present disclosure, the embodiments together with the drawings are described in detail as follows. However, the drawings are used only for the purpose of indicating and supporting the specification, which is not necessarily the real proportion and precise configuration after the implementation of the present disclosure. Therefore, the relations of the proportion and configuration of the attached drawings should not be interpreted to limit the actual scope of implementation of the present disclosure.

In accordance with the embodiment(s) of the present disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

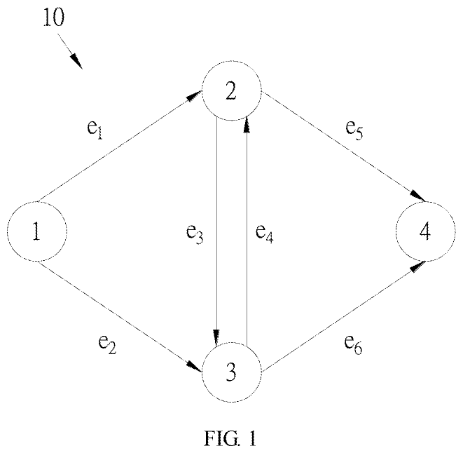

Please refer to FIG. 1, illustrating the schematic diagram of the multi-state flow network of the embodiment of the present disclosure. For the multi-state flow network 10, G (V, E, D) can be used to show multiple states of a network model, wherein V={1,2,3,4} is the node set of the multi-state flow network 10 and the number of the nodes is 4. A source node and a sink node for transmission are disposed in those nodes. Taking FIG. 1 as an example, node 1 is the source node of the multi-state flow network 10, and node 4 is the sink node of the multi-state flow network 10. The flow of data or objects will flow from the source node finally to the sink node. E={e₁, e₂, e₃, e₄, e₅, e₆} is the connecting arcs which connect 4 nodes. Arc e₁ connects node 1 to node 2. The rest can be reasoned in the same way. D={d₁, d₂, d₃, d₄, d₅, d₆} is the maximal load of each arc during transmission. d₁ refers to the amount of data or information that can be transmitted by arc e₁ which connects node 1 to node 2. The rest can be reasoned in the same way.

Each node can be connected to generate a plurality of transmission paths from the source node to the sink node through the arcs. Then, data is transmitted from the source node to the sink node from these paths. Taking computers or communication systems as an example, the source node may be a terminal device that transmits messages or commands. Messages and commands can be sent to the other terminal devices through computer mainframes or portable devices, by wired or wireless transmissions, such as web servers or communication servers, the transmission paths of which can be regarded as connecting arcs. Finally, the allocated data is transmitted to cloud servers for recording and analysis, which can be regarded as sink nodes. Noise may be generated during transmission, leading to increase in the amount of extra information for transmitted data, or the amount of information for transmitted data is decreased due to the loss of signals. The transmission capacity carried on different transmission paths is also limited, such as network bandwidth. Therefore, when analyzing the transmission network reliability with the multi-state flow network 10, the transmission load must be taken into consideration.

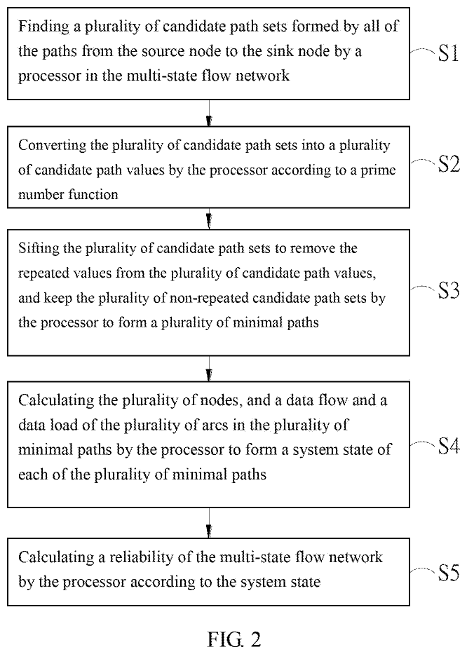

Please refer to FIG. 2, illustrating the flow chart of the reliability evaluating method for the multi-state flow network of the embodiment of the present disclosure. The following steps are explained together with the multi-state flow network shown in FIG. 2. As shown in the drawing, the method of evaluating network reliability includes the following steps (S1˜S5):

S1: Finding a plurality of candidate path sets formed by all of the paths from the source node to the sink node by a processor in the multi-state flow network. Taking the multi-state flow network 10 as an example, all paths from the source node (node 1) to the sink node (node 4) can include any combination of connecting arcs E={e₁, e₂, e₃, e₄, e₅, e₆}. Although effective transmission paths may not be formed by any combination under the consideration of transmission directions or node connection, multiple candidate paths can be selected to conduct a follow-up analysis on the network reliability under the conditions stated above. For example, 7 sets S={s₁, s₂, s₃, s₄, s₅, s₆, s₇} of candidate path sets can be found. The detailed candidate path sets can include: s₁={e₁, e₅}, s₂={e₁, e₃, e₆}, s₃={e₂, e₄, e₅}, s₄={e₁, e₃, e₆}, s₅={e₁, e₆}, s₆={e₂, e₆}, s₇={e₁, e₃, e₆}. There is no special restriction on the choice of candidate path sets. The conventional traffic network models include the Enumeration method or the Minimal Path method. Please refer to W. C. Yeh, “Search for all d-mincuts of a limited-flow network” Computers & Operations Research, 29(13), 1843-1858 (2002). However, repeated paths tend to occur among the candidate path sets. For example, considering the integrity of the candidate paths, it is possible to generate repeated results by listing out the possible candidate path sets in different ways of selection.

To avoid the difficulty in operation of the follow-up reliability analysis caused by the repeated candidate path sets, it is necessary to remove the repeated part. However, the existing removing methods include two main methods stated as follows: The first method is to regard a single path set (e.g. s₁) as a basis, and compare it with other sets (e.g. s₂-s₇) each by each. The set will be marked until the same sets are found, and comparison for the following sets continues. The other method is to arrange the sets, and select the same parts of adjacent sets after the arrangement of all the candidate sets according to the sequence of the elements in the sets. The above-mentioned methods require a lot more amount of time for operation. Too much time on operation will be wasted in either the method of comparison each by each or that of complete arrangement in a more complicated multi-state flow network with nodes and connecting arcs. Therefore, the present disclosure further proposes a new sifting and removing method, described as follows:

S2: Converting the plurality of candidate path sets into a plurality of candidate path values by the processor according to a prime number function. To effectively sift the candidate path set, the candidate path set can be converted into a single value by the prime number function. Direct value comparison can effectively reduce the burden on system operation compared with set comparison. A prime number refers to a number with no factor other than 1 and itself, meaning the number cannot completely be divided by other natural numbers except for 1 and the numbers among the natural numbers that are greater than 1, such as 2, 3, 5, 7, 11 . . . . Specifically, the prime number function can be a product value of non-repeated prime numbers with an exponentiation operation. In this embodiment, the equation P(s)=pᵢ^{e}^{ᵢ}×pᵢ₊₁^{e}^{ᵢ₊₁}× . . . ×pₙ^{e}^{ₙ} can be used to represent the prime number function in the present disclosure, wherein s represents the plurality of candidate path sets, eᵢ represents the i-th element in the plurality of candidate path sets, pᵢ represents the i-th non-repeated prime number, and n represents the number of elements. Taking the above-mentioned candidate path S={s₁, s₂, s₃, s₄, s₅, s₆, s₇} as an example, it can be converted into the candidate path value P(s) as shown in Table 1 below.

TABLE 1

| s | e₁ | e₂ | e₃ | e₄ | e₅ | e₆ | P(sᵢ) |
|---|---|---|---|---|---|---|---|
| s₁ | 1 | | | | 1 | | 2¹ *11¹ = 22 |
| s₂ | 1 | | 1 | | | 1 | 2¹ *5¹ *13¹ = 130 |
| s₃ | | 1 | | 1 | 1 | | 3¹ *7¹ *11¹ = 231 |
| s₄ | 1 | | 1 | | | 1 | 2¹ *5¹ *13¹ = 130 |
| s₅ | 1 | | | | | 1 | 2¹ *13¹ = 26 |
| s₆ | | 1 | | | | 1 | 3¹ *13¹ = 39 |
| s₇ | 1 | | 1 | | | 1 | 2¹ *5¹ *13¹ = 130 |

Step 3: Sifting the plurality of candidate path sets to remove the repeated values from the plurality of candidate path values, and keep the plurality of non-repeated candidate path sets by the processor to form a plurality of minimal paths. As seen in Table 1, among the 7 sets S={s₁, s₂, s₃, s₄, s₅, s₆, s₇} of candidate path sets, s2, s4 and s7 have the same candidate path values. The product value of the non-repeated prime numbers with the exponentiation operation do not have repeated values, when the calculated candidate path values are the same, the above-mentioned three sets should belong to the same candidate path sets. The repeated candidate path sets should be removed before the follow-up reliability calculation. Only a plurality of non-repeated candidate path sets S1={s₁, s₂, s₃, s₅, s₆} are kept as the minimal path set for a follow-up analysis. Removing the repeated path sets by the sifting method disclosed in the present disclosure can reduce the number of operations required for follow-up operational reliability calculation, thus improving the operational efficiency.

In the other embodiment, the prime number function can include a logarithmic value of the product value of the plurality of non-repeated prime numbers with the exponentiation operation. The equation L(s)=L(P(s)) is used to represent the prime number function in the present disclosure. Considering the characteristics of the logarithmic value, the equation can be expanded as L(s)=log(P(s))=log(pᵢ^{e}^{ᵢ}×pᵢ₊₁^{e}^{ᵢ₊₁}× . . . pₙ^{e}^{ₙ})=eᵢ log(pᵢ)+eᵢ₊₁ log(pᵢ₊₁)+ . . . +eₙ log(pₙ). The purpose of taking logarithmic value is to avoid overlarge product values of the exponentiation operation to the prime number that would lead to the number of bits for operation exceeding the processing range of the processor when the number of elements n is larger, which will elevate the difficulty in operation. By the taken logarithmic values of the prime numbers stated above, the candidate path set S={s₁, s₂, s₃, s₄, s₅, s₆, s₇} can be converted into the candidate path value L(s) shown in Table 2 below.

TABLE 2

| s | e₁ | e₂ | e₃ | e₄ | e₅ | e₆ | L(sᵢ) |
|---|---|---|---|---|---|---|---|
| s₁ | 1 | | | | 1 | | log(2) + log(11) = 1.342423 |
| s₂ | 1 | | 1 | | | 1 | log(2) + log(5) + log(13) = 2.113943 |
| s₃ | | 1 | | 1 | 1 | | log(3) + log(7) + log(11) = 2.217484 |
| s₄ | 1 | | 1 | | | 1 | log(2) + log(5) + log(13) = 2.363611 |
| s₅ | 1 | | | | | 1 | log(2) + log(13) = 1.414973 |
| s₆ | | 1 | | | | 1 | log(3) + log(13) = 1.591065 |
| s₇ | 1 | | 1 | | | 1 | log(2) + log(5) + log(13) = 2.113943 |

As seen in Table 2, among the 7 sets S={s₁, s₂, s₃, s₄, s₅, s₆, s₇} of candidate path sets, s2, s4 and s7 have the same candidate path values, which is the same as what is mentioned in the previous embodiment. The product value of the non-repeated prime numbers with the exponentiation operation does not have repeated values. Therefore, repeated values do not occur even after taking logarithmic values. The above-mentioned candidate path values are the same, which means that the above-mentioned three sets should belong to the same candidate path sets. The repeated candidate path sets should be removed and only a plurality of non-repeated candidate path sets S1={s₁, s₂, s₃, s₅, s₆} should be kept for a follow-up analysis of the minimal path sets.

S4: Calculating the plurality of nodes, and a data flow and a data load of the plurality of arcs in the plurality of minimal paths by the processor to form a system state of each of the plurality of minimal paths. The possible candidate paths of the multi-state flow network 10 can be listed according to the steps stated above, and the path sets can be converted into values for the convenience of finding out whether there are repeated sets in the comparing process to further remove repeated path sets and obtain the minimal path sets. Through obtaining the minimal path sets, a system state of each minimal path can be formed with the data flow of each node and the data load of the connecting arcs.

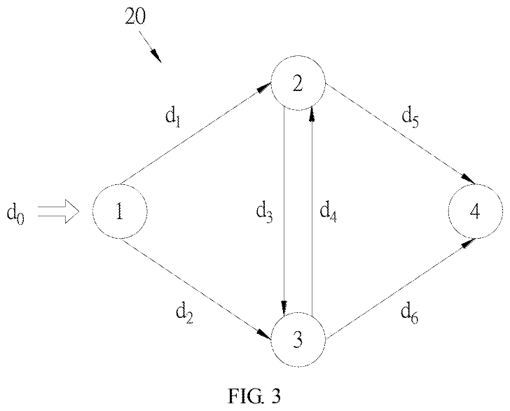

Please refer to FIG. 3, illustrating the schematic diagram of the multi-state flow network of the other embodiment of the present disclosure. As shown in the drawing, in the multi-state flow network 20, D={d₁, d₂, d₃, d₄, d₅, d₆} is the maximal load corresponding to each arc E={e₁, e₂, e₃, e₄, e₅, e₆} in the transmission process. For example, the data input d₀ of the input source node (node 1) can be 1. When passing the minimal path set s₁={e₁, e₅}, the data transmission capacity can be formed into the system state of d₁={d₁, d₅} with d₁=2 and d₅=3. Therefore, the amount of data transmitted to the sink node (node 4) is 3. The increase in the amount of data is due to the possible learning effect the multi-state flow network 20 may have, resulting in the increase in the amount of data in the transmission process. The amount of data may also be reduced or lost during the transmission process, but the data transmission capacity will not exceed the network bearing capacity. The data flow and data load of the multi-state flow network 20 will be beneficial to the evaluation on the reliability of the data transmitted from the source node to the sink node.

In step 3, the candidate path sets are converted into a plurality of candidate path values. In the other embodiment, it is also possible to convert the candidate path sets into candidate system state sets, that is, conducting a sifting process by the transmission load. For example, the above-mentioned candidate path sets S={s₁, s₂, s₃, s₄, s₅, s₆, s₇} can be converted into D₁={d₁, d₅}, D₂={d₁, d₃, d₆}, D₃={d₂, d₄, d₅}, D₄={d₁, d₃, d₆}, D₅={d₁, d₆}, D₆={d₂, d₆}, D₇={d₁, d₃, d₆} which include the system states. The system state sets stated above can also be converted into system state values L(Dᵢ) by using the prime number function, as shown in Table 3.

TABLE 3

| Dᵢ | d₁ | d₂ | d₃ | d₄ | d₅ | d₆ | L(Dᵢ) |
|---|---|---|---|---|---|---|---|
| D₁ | 2 | | | | 3 | | 2log(2) + 3log(11) = 3.726238 |
| D₂ | 2 | | 2 | | | 3 | 2log(2) + 2log(5) + 3log(13) = |
| | | | | | | | 5.341830 |
| D₃ | | 1 | | 2 | 3 | | log(3) + 2log(7) + 3log(11) = |
| | | | | | | | 5.291495 |
| D₄ | 2 | | 2 | | | 3 | 2log(2) + 2log(5) + 3log(13) = |
| | | | | | | | 5.341830 |
| D₅ | 2 | | | | | 3 | 2log(2) + 3log(13) = 3.943890 |
| D₆ | | 1 | | | | 3 | log(3) + 3log(13) = 3.818951 |
| D₇ | 2 | | 3 | | | 3 | 2log(2) + 3log(5) + 3log(13) = |
| | | | | | | | 6.040800 |

As seen in Table 2, among the 7 candidate path sets corresponding to the system states, D₂ and D₄ have the same system state values. What differentiates from the previous embodiment is that although D₇ has the same transmission path, the differences in data transmission capacity will result in the sets which might not be the same. In this embodiment, only one of the repeated system state values D₂ and D₄ needs to be removed and the repeated set can be sifted so that the operation of analyzing the network reliability does not cause the problem of repeated operations.

S5: Calculating a reliability of the multi-state flow network by the processor according to the system state. In the steps stated above, by means of the determination corresponding to the minimal path of the multi-state flow network, the system state calculates the reliability of the network system through the reliability equation, which can be regarded as a basis for decision-making on determining the multi-state flow network system. The reliability can be obtained according to the following equation.

R_{LP}=Pr(Uᵢ₌₁^{δ}Xᵢ)=Σᵢ₌₁^{δ}Pr(Xᵢ)−Σⱼ₌₂^{δ}Σᵢ₌₁^{j-1}Pr(Xᵢ∩Xⱼ)+(−1)^{δ-1}Pr(X₁∩X₂∩ . . . ∩X_{δ})

Pr(X)=Πᵢ₌₁^{m}Pr({x*ᵢ|xᵢ≤x*ᵢ≤W(eᵢ) and X=(x₁, x₂ . . . xₘ)}), wherein, X=(x1, x2, . . . , xm) is the vector of the system state of the minimal path corresponding to the multi-state flow network.

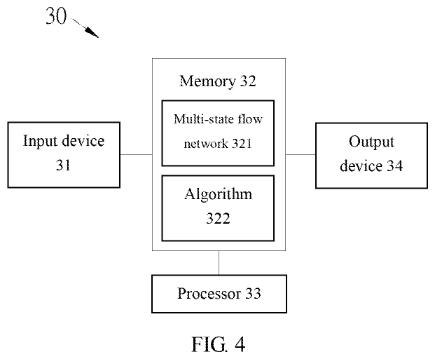

Please refer to FIG. 4, illustrating the schematic diagram of the reliability evaluating system for the multi-state flow network of the embodiment of the present disclosure. As shown in the drawing, the reliability evaluating system 30 for a multi-state flow network of the present disclosure includes an input device 31, a memory 32, a processor 33, and an output device 34. Wherein, the input device 31 is connected to the memory 32, which includes every kind of input interfaces of computer devices or file-receiving devices. The input device 31 is used to receive the structure of the multi-state flow network 321 including the nodes and the arcs which are then stored in the memory 32. The nodes of the multi-state flow network 321 can correspond to each terminal device. The connecting arcs include every kind of wired or wireless transmission methods. In addition, the memory 32 can store an algorithm 322 that includes the reliability evaluating method of the multi-state flow network 321 described above. The steps of the algorithm 322 are the same as those disclosed in the embodiments mentioned above, and the details are not explained again. The memory 32 can include a read only memory, a flash memory, a disk, or a cloud database, etc.

In addition, the system further includes a processor 33 connected to the memory 32. The processor 33 includes a central-processing unit, an image processor, a microprocessor, etc., which may include a multi-core processing unit or a combination of multiple processing units. The processor 33 can access the multi-state flow network 321 and the algorithm 322 in the memory 22 to perform the algorithm of the evaluation analysis as shown in FIG. 2. In operation, the processor 33 executes the algorithm stored in the memory 32, and uses the instructions included in each step to sift the repeated sets in advance to reduce the resource consumption caused by the data repetition operation. Afterwards, it calculates the transmission reliability of the multi-state flow network 321 according to the sifted information.

The result calculated by the processor 33 can be outputted by the output device 34. The output device 34 can be a display that presents evaluation results, such as LCD, LED, and OLED displays, or the output device 34 can be a wired or wireless network transmitter that transmits the evaluation results to remote users to evaluate the possible results of actual system operation by the reliability evaluation.

The embodiments stated above are only illustrative examples which do not limit the present disclosure. Any spirit and scope without departing from the present disclosure as to equivalent modifications or alterations is intended to be included in the following claims.

What is claimed is:

1. A reliability evaluating method for a multi-state flow network, a multi-state flow network being stored in a memory, the multi-state flow network comprising a plurality of nodes and a plurality of arcs connected to the plurality of nodes, the plurality of nodes comprising a source node and a sink node, and the reliability evaluating method comprising the following steps:
finding a plurality of candidate path sets formed by all of the paths from the source node to the sink node by a processor in the multi-state flow network;
converting the plurality of candidate path sets into a plurality of candidate path values by the processor according to a prime number function;
sifting the plurality of candidate path sets to remove repeated values from the plurality of candidate path values, and keep the plurality of non-repeated candidate path sets by the processor to form a plurality of minimal paths;
calculating the plurality of nodes, and a data flow and a data load of the plurality of arcs in the plurality of minimal paths by the processor to form a system state of each of the plurality of minimal paths; and
calculating a reliability of the multi-state flow network by the processor according to the system state.

2. The reliability evaluating method for the multi-state flow network according to claim 1, wherein the prime number function comprises a product value of a plurality of non-repeated prime numbers with an exponentiation operation, shown as P(s)=pᵢ^{e}^{ᵢ}×pᵢ₊₁^{e}^{ᵢ₊₁}× . . . pₙ^{e}^{ₙ}, wherein s represents the plurality of candidate path sets, eᵢ represents the i-th element in the plurality of candidate path sets, pᵢ represents the i-th non-repeated prime number, and n represents the number of elements.

3. The reliability evaluating method for the multi-state flow network according to claim 2, wherein the prime number function comprises a logarithmic value of the product value of the plurality of non-repeated prime numbers with the exponentiation operation, shown as L(s)=L(P(s)), wherein L(P(s)) represents the logarithmic value of P(s).

4. The reliability evaluating method for the multi-state flow network according to claim 1, wherein the system state of the plurality of minimal paths is converted into a plurality of system state values according to the prime number function and the plurality of system state values are sifted to keep non-repeated values corresponded to the system state.

5. A reliability evaluating system for a multi-state flow network, applicable to a multi-state flow network, the multi-state flow network comprising a plurality of nodes and a plurality of arcs connected to the plurality of nodes, the plurality of nodes comprising a source node and a sink node, and the reliability evaluating system comprising:
a memory, storing the multi-state flow network and an algorithm, wherein the algorithm comprises the following steps:
finding a plurality of candidate path sets formed by all of the paths from the source node to the sink node in the multi-state flow network;
converting the plurality of candidate path sets into a plurality of candidate path values according to a prime number function;
sifting the plurality of candidate path sets to remove repeated values from the plurality of candidate path values, and keep the plurality of non-repeated candidate path sets to form a plurality of minimal paths;
calculating the plurality of nodes, and a data flow and a data load of the plurality of arcs in the plurality of minimal paths to form a system state of each of the plurality of minimal paths; and
calculating a reliability of the multi-state flow network according to the system state; and
a processor, connected to the multi-state flow network and the memory, executing the algorithm to obtain the reliability of the multi-state flow network.

6. The reliability evaluating system for the multi-state flow network according to claim 5, wherein the prime number function comprises a product value of a plurality of non-repeated prime numbers with an exponentiation operation, shown as P(s)=pᵢ^{e}^{ᵢ}×pᵢ₊₁^{e}^{ᵢ₊₁}× . . . ×pₙ^{e}^{ₙ}, wherein s represents the plurality of candidate path sets, eᵢ represents the i-th element in the plurality of candidate path sets, pᵢ represents the i-th non-repeated prime number, and n represents the number of elements.

7. The reliability evaluating system for the multi-state flow network according to claim 6, wherein the prime number function comprises a logarithmic value of the product value of the plurality of non-repeated prime numbers with the exponentiation operation, shown as L(s)=L(P(s)), wherein L(P(s)) represents the logarithmic value of P(s).

8. The reliability evaluating system for the multi-state flow network according to claim 5, wherein the system state of the plurality of minimal paths is converted into a plurality of system state values according to the prime number function and the plurality of system state values are sifted to keep non-repeated values corresponded to the system state.
